(19) United States
(12) Patent Application Publication
(10) Pub. No.: US 2013/0175209 A1
(43) Pub. Date: Jul. 11, 2013

(54) CLARIFIER

(71) Applicants: Juho Roine, Helsinki (FI); Gennadi Zaitsev, Hikia (FI)

(72) Inventors: Juho Roine, Helsinki (FI); Gennadi Zaitsev, Hikia (FI)

(21) Appl. No.: 13/816,286

(22) PCT Filed: Aug. 10, 2011
(86) PCT No.: PCT/FI11/50704

§ 371 Date: Feb. 11, 2013

(30) Foreign Application Priority Data
Aug. 11, 2010 (FI) 20105843

(51) Int. Cl. B01D 21/24

(52) U.S. Cl. CPC B01D 21/2422
USPC 210/151; 210/521

(57) ABSTRACT

A clarifier for attachment with a water treatment facility, the clarifier having inlet means for water coming in from the treatment facility and outlet means for clarified water, and means for removing bottom sludge from the clarification tank. The clarifier is divided into a supply chamber with said inlet means opening thereto, as well as a clarification chamber with said outlet connection opening thereto. Between the chambers is a separating partition, which extends from a top region of the clarifier downward to terminate at a distance from a bottom part of the clarifier for establishing a gap between the partition's lower edge and the bottom part, said chambers being thereby in flow communication with each other.

The present invention relates to a clarifier for attachment with a water treatment facility, particularly a sewage treatment plant, said clarifier having inlet means for water coming in from the treatment facility and outlet means for clarified water, as well as means for removing bottom sludge from the clarifier.

Water treatment plants make use of various biological processes for actual cleaning, such as e.g. an activated sludge method and various bioreactors.

Prior known are several different bioreactors for wastewater treatment, such as e.g. trickle filters, biorotors (rotating biological contactors), fluidized bed reactors, fixed bed reactors and moving bed reactors, as well as a rotating bed bioreactor, RBBR, developed by the present Applicant. In such processes, the treated water is typically conducted into a clarifier with sludge present therein settling to a bottom of the clarifier and clarified water being removed from the clarifier, e.g. into a sewage ditch.

A problem with prior known clarifiers is that the bottom sludge occasionally develops gas bubbles as a result of bacterial activity, the gas bubbles making the sludge lighter and allowing some of it to rise to the surface. Water to be removed from the clarifier becomes clouded by such surfaced sludge with a content of organic matter, whereby a sufficiently high standard of water purification is not reached.

An objective of the present invention is to provide a clarifier solution capable of effectively eliminating this surface sludge problem.

In order to achieve this objective, a clarifier according to the invention is characterized in that the clarifier is divided into a supply chamber with said inlet means opening thereto, as well as a clarification chamber with said outlet connection opening thereto, said chambers having there between a separating partition, which extends from a top region of the clarifier downward to terminate at a distance from a bottom part of the clarifier for establishing a gap between the partition's lower edge and the bottom part, said chambers being thereby in flow communication with each other; that in a top region of the partition is formed an overflow channel, which on the supply chamber side is provided with a first port, whereby the water, flowing from the treatment plant through the inlet means into the supply clamber, is able to enter the overflow channel and further to be circulated into the treatment plant; and that the overflow channel is also provided on the clarification chamber side with a second port, which is smaller than the first port in terms of its cross-sectional flow area and/or said second port has its lower edge in a position lower down than the lower edge of the first port.

Such a solution according to the invention enables removing surface sludge from the clarification chamber side effectively as well as in a reliable fashion.

The invention will now be described more closely with reference to the accompanying drawings, in which:

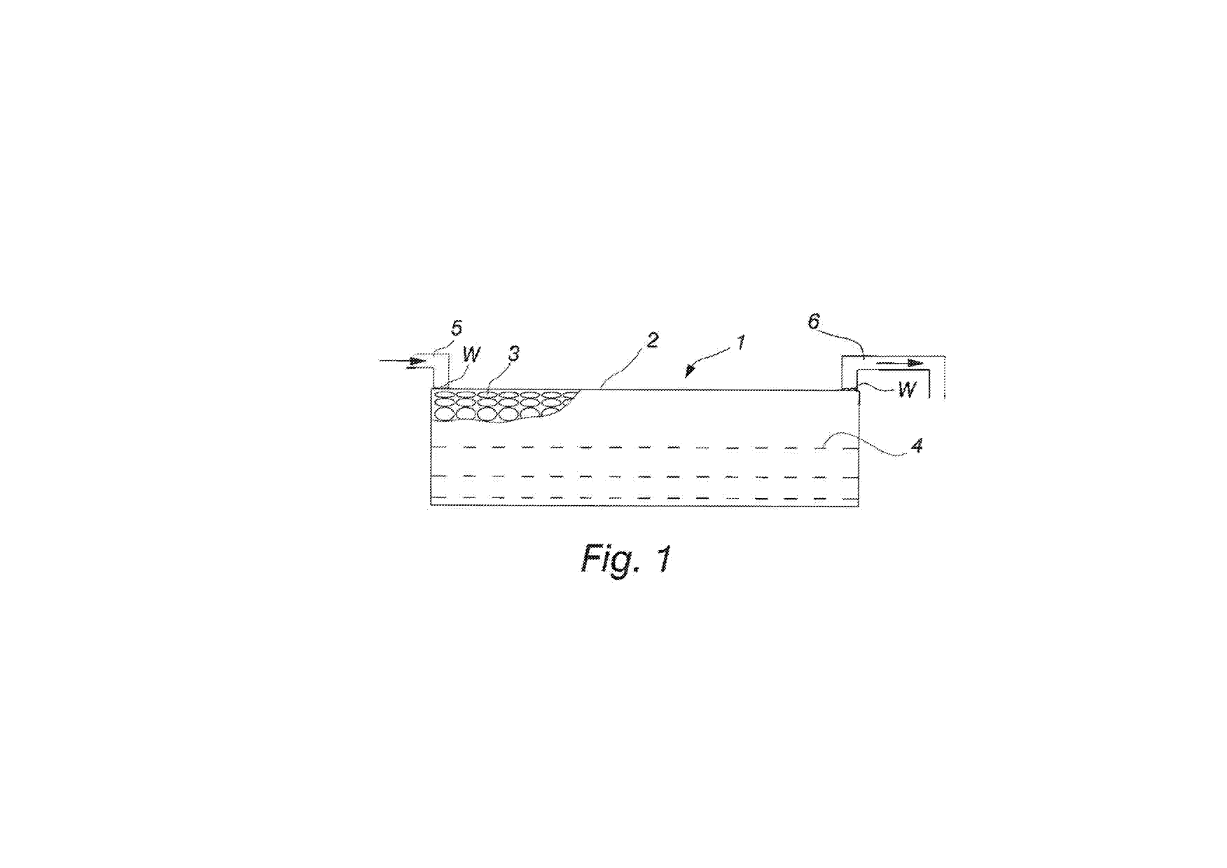

FIG. 1 shows one rotationally working bioreactor of the prior art,

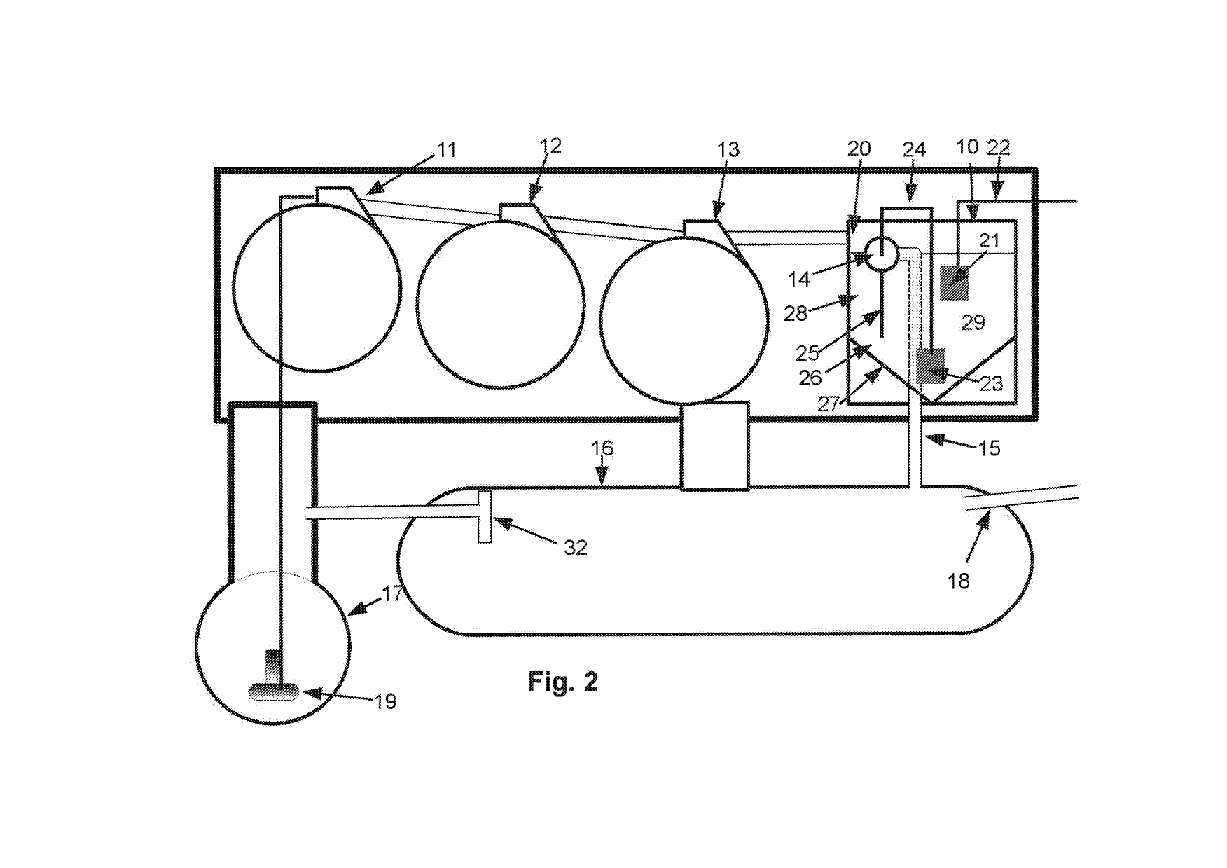

FIG. 2 shows one embodiment for a clarifier of the invention in a schematic view of principle in connection with one sewage treatment solution, and

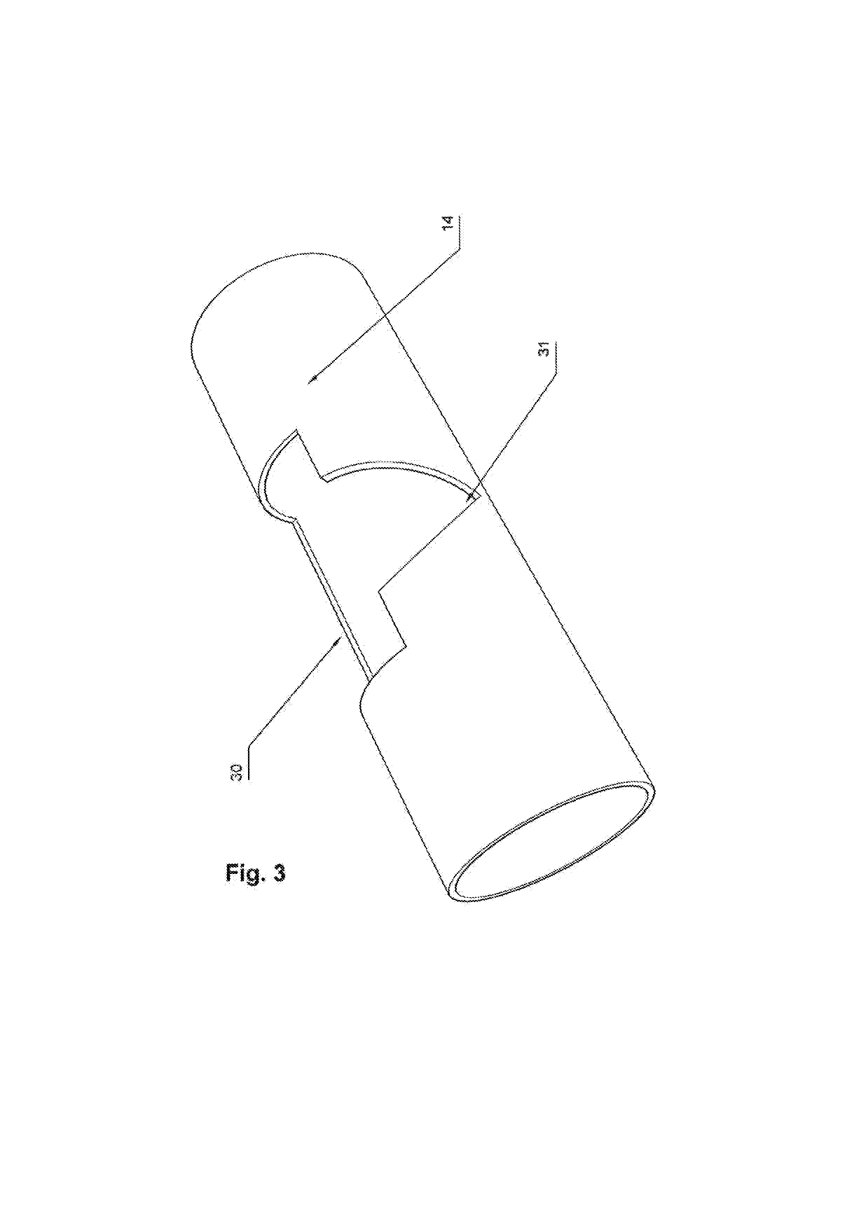

FIG. 3 shows one detail in the embodiment of FIG. 2.

A rotating bed bioreactor 1, shown in FIG. 1 and presented in more detail in the present Applicant's earlier application publication WO 2007/077298, comprises an elongated tubular tank section 2, which is preferably circular or elliptical in its cross-section. The tank section 2 is provided with inlet means 5 for water to be purified and outlet means 6 for purified water, as well as with means 4 for supplying a fluid containing a reaction gas required by the purification process, preferably such that the water to be purified develops reaction-gas containing gas bubbles, such as e.g. for supplying air required by an aerobic purification process in form of air bubbles from which the air dissolves in water for oxidizing the latter for use by bacteria. The fluid may also be pre-aerated water, in which the air can be in the form of air bubbles and/or in a previously dissolved form for oxygen-rich water. In the illustrated case, shown only by way of example, the water inlet means 5 and outlet means 6 are disposed at longitudinally opposite ends of the tank section 2 in a top ridge region of the tank section. The inlet and/or outlet means may also be located elsewhere in the tank section 2, in such an arrangement that the supply of water to be purified and the removal of purified water can be conducted in such a way that the tank section 2 is essentially full of water during the purification process. The water level is marked in the figures with the letter W. The supply of water to be purified proceeds preferably in a continuous manner, e.g. by preceding the bioreactor with a compensation tank with water to be purified being collected therein and pumped therefrom in a constant supply into the bioreactor by way of the pipe 5. The supply of water to be purified may also be effected by some other type of procedure, wherein water to be purified is supplied into the tank section to fill it up, the air blasting is initiated for effecting the spinning motion and oxidation and, after the purification process has ended, the air blasting is terminated and the tank section is drained of purified water, after which the process is started from the beginning.

Inside the tank section is arranged a carrier medium 3, on top of which microorganisms 3 may deposit for a biofilm. The carrier medium may consist e.g. of a single piece of carrier material or several agglomerated pieces of carrier material or several separate pieces of carrier material, whereby, when using a plurality of carrier pieces, such pieces can be identical to or different from each other e.g. in terms of the size, shape, density and/or other properties thereof.

Such a rotating bed bioreactor can be used e.g. as part of a purification system for the black and/or grey wastewaters of a single house, such that the bioreactor is preceded by a septic section and an anaerobic section, after which the water to be purified is delivered into the bioreactor for aerobic purification. The bioreactor is preferably followed by yet another aerobic bioreactor, in which can be performed a nitrification (NH₃→NO₂⁻→NO₃⁻), after which the water is conducted to a denitrification process. Finally, the purified water is delivered e.g. to a phosphor precipitation section and into a clarifier of the present invention.

Such a rotating bed bioreactor can be used in a variety of applications, such as in sewage treatment facilities, car washes, laundries, fish farms, and in the purification of e.g. swimming pool cleaning waters, landfill seepage waters, mine effluents, industrial soap waters and washing waters, and effluents from flue gas scrubbers, etc., and a number of bioreactors can be in succession and/or in parallel.

Another way of constructing a bioreactor is that the tank section is divided into two or more compartments, whereby some of the compartments may function aerobically, i.e. therein the air supply is adapted to spin a carrier, air bubbles, and water in continuous action during the purification process, and some compartments may work in an anaerobic manner. In an anaerobic process, the supply of a fluid causing the spinning motion is intermittent or optionally the carrier is set in continuous or discontinuous spinning motion by circulating water or other fluid by way of openings in the reactor's wall, said fluid not having dissolved oxygen and/or oxygen-bearing gas bubbles in the amount required by an aerobic process.

The spinning motion can also be instigated with a fluid other than air, e.g. with water, which has been pre-aerated prior to its delivery into a tank section containing water to be purified, and which water is delivered in such a way that the air present therein produces bubbles in the tank section containing water to be purified. The pre-aerated water may also contain the air in a substantially dissolved state, whereby the dissolved air containing, oxygen-rich water is able to function in an aerobic process even without a substantial formation of bubbles. The purification process can be a process necessitating also a gas other than oxygen, in which case the supplied fluid can be a gas or gas mixture other than air, or it can also be water or other liquid containing this particular reaction gas.

FIG. 2 illustrates one embodiment for a clarifier 10 of the invention in a schematic view of principle in connection with one sewage treatment solution. This treatment solution includes three rotary type bioreactors 11, 12, 13, the first 11 of which operates anaerobically and the next two 12, 13 aerobically. In the first bioreactor 11 is thus conducted a denitrification, and in the second one 12 a removal of organic matter, and in the third one 13 a nitrification. The bioreactors are in flow communication with each other, and from the final bioreactor 13 the purified water is conducted into the clarifier 10. The clarifier is connected by way of an overflow channel 14 and an overflow pipe 15 to a septic tank 16, which in turn is in flow communication with a pump well 17. From the pump well, the purified water is conducted into the first bioreactor 11 by means of a pump 19.

The clarifier 10 is divided into a supply chamber 28, in which the purified water coming from the final bioreactor 13 of a treatment plant arrives by way of an inlet connection 20, as well as into an actual clarification section or clarification chamber 29, from which the clarified water is removed by means of a pump 21 through an outlet pipe 22. Between the chambers is a separating partition 25, which extends from a top region of the clarifier downward to terminate at a distance from a bottom part 27 of the clarifier so as to establish between the partition's lower edge and the bottom part a gap 26, by way of which said chambers are in flow communication with each other. The partition 25 has its top region provided with the overflow channel 14, which is in flow communication with the septic tank 16 by way of the pipe 15.

FIG. 3 depicts one embodiment for the overflow channel of a clarifier according to the invention in a more detailed partial view, which only shows details essential from the standpoint of the invention. The overflow channel 14 is provided according to the invention with a first port 30, which, when the overflow channel is in a mounted condition on the clarifier, opens towards the supply chamber 28, and with a second port 31, which in turn opens towards the clarification chamber 29. The port 30 is preferably rectangular in cross-section, and the port 31, in turn, preferably V-shaped. In the illustrated embodiment, said ports 30 and 31 are jointed to each other to make up a continuous opening in a top region of the overflow channel 14, but said ports can also be designed as separate openings. The ports are dimensioned in such a way that the port 30 on the supply chamber side is larger in terms of its cross-sectional flow area than the port 31 on the clarification chamber side, and, in addition, the port 31 on the clarification chamber side has its lower edge lying in a slightly lower position than the lower edge of the port 30 on the supply chamber side.

A sewage drain extending to the septic tank is marked with reference numeral 18. The solids contained in sewage deposits on a bottom of the tank. From the septic tank, the water overflows into the pump well by way of a T-branch 32, whereby the surface sludge of the septic tank is not able to enter the purification process. From the pump well, water is circulated through the bioreactors 11-13 into the clarifier 10. From the clarifier flows a pumping-equaling amount by way of the overflow channel 14 and the overflow pipe 15 into the septic tank 16 and back into the pump well 17. Such circulation flow is maintained active preferably all the time, e.g. as timed to occur in 30 s cycles at 15 minute intervals, and in a constant flow, and it can be adjusted by varying the running time, interval, and operating frequency of the pump 19. During the course of circulation flow, the water level in the clarification chamber rises first to match the water level in the supply chamber, but sinks more slowly due to the dimensioning of ports, whereby, after the supply chamber's water level has settled at a lower edge of the first port 30, the flow still continues from the clarification chamber side as a surface flow, the surface sludge formed on the surface in the clarification chamber discharging effectively into the overflow channel and further into the septic tank 16. The bottom sludge formed on the clarifier's bottom 27 is removed by means of a sludge pump 23 through a pipe 24 into the overflow channel and further into the septic tank 16.

When fresh sewage arrives in the system, the water overflowing from the septic tank accumulates in the pump well and the circulation pumping is continued as per normal. At this time, an outlet pump 21 of the clarifier is activated for a moment, whereby the surface level in the clarifier descends a little and the water coming from the bioreactor 13 travels, forced by the partition 25, downward onto the side of the clarification chamber 29. Timed activations of the outlet pump 21 are continued until the required amount of water has been expelled from the system. The outlet flow must fall short of the circulation flow.

A clarifier of the invention has been shown above in association with a rotationally working bioreactor, but its use is conceivable in connection of many other bioreactors or treatment facilities. The clarifier is suitable for use both in batch and continuous operation.

1. A clarifier (10) for attachment with a water treatment facility, particularly a sewage treatment plant, said clarifier having inlet means (20) for water coming in from the treatment facility and outlet means (21, 22) for clarified water, as well as means (23, 24) for removing bottom sludge from the clarification tank, characterized in that the clarifier is divided into a supply chamber (28) with said inlet means (20) opening thereto, as well as a clarification chamber (29) with said outlet means opening thereto, wherein said chambers having therebetween a separating partition (25), which extends from a top region of the clarifier downward to terminate at a distance from a bottom part (27) of the clarifier for establishing a gap (26) between the partition's lower edge and the bottom part, said chambers being thereby in flow communication with each other; wherein in a top region of the partition (25) is formed an over-flow channel (14), which on a side towards the supply chamber (28) is provided with a first port (30), whereby the water, flowing from the treatment plant through the inlet means (20) into the supply clamber (28), is able to enter the overflow channel (14) and further to be circulated into the treatment plant; and that the overflow channel is also provided on a side towards the clarification chamber (29) with a second port (31), which is smaller than the first port (30) in terms of its cross-sectional flow area and/or said second port has its lower edge in a position lower down than the lower edge of the first port (30).

2. A clarifier as set forth in claim 1, characterized in that said first port (30) is substantially rectangular in shape.

3. A clarifier as set forth in claim 1, characterized in that said second port (31) is substantially V-shaped.

4. A clarifier as set forth in claim 1, characterized in that said first and second ports (30, 31) join each other to make up a continuous opening in a top part of the inlet channel (14).

5. A sewage treatment plant, comprising at least one rotating bed bioreactor which includes a tank section (2), which is substantially circular or elliptical in cross-section and which is provided with inlet means (5) for water to be purified and outlet means (6) for purified water, inside which tank is present a carrier medium (3) on top of which may develop a biofilm, and in which tank is further provided means (4) for supplying a fluid containing a reaction gas required by the purification process, and which tank section (2), during the course of purification process, is essentially full of water, and said reactor including control elements for operating the fluid supply means in such a way that the latter set the carrier medium, water, and reaction-gas bearing fluid in spinning motion around a center line of rotation extending essentially through the cross-sectional center of the tank, characterized in that the treatment plant is fitted with a clarifier as set forth in claim 1.
